(19) United States
(12) Patent Application Publication
(10) Pub. No.: US 2012/0199753 A1
(43) Pub. Date: Aug. 9, 2012

(54) Portable Detection Apparatus

(75) Inventors: Tsuey Fen Chuang, Irvine, CA (US); David F. Morrison, II, Hesperia, CA (US); Richard Calvin Sinclair, Oceanside, CA (US); Bryan Lee Slack, Yucca Valley, CA (US); Roger W.A. Spillmann, Riverside, CA (US); Vladimir Stanich, Poway, CA (US)

(73) Assignee: CLEAR PATH TECHNOLOGIES, INC., Corona, CA (US)

(21) Appl. No.: 13/384,262

(22) PCT Filed: Jul. 21, 2010
(86) PCT No.: PCT/US10/42746

§ 371 Date: Jan. 16, 2012

Related U.S. Application Data
(60) Provisional application No. 61/227,199, filed on Jul. 21, 2009.

(51) Int. Cl. G01N 23/02

(52) U.S. Cl. 250/390.04

(57) ABSTRACT

A portable detection apparatus for scanning a target object comprises, in an exemplary embodiment, a tower unit, sensor unit and electronics unit, each configured for removable engagement with one another for relatively quick disassembly during transport and storage and reassembly during use. Additionally, each unit is sized and configured for ease of transport and for being able to operate in relatively confined spaces. The sensor unit is configured for selective engagement with a vertically oriented tower column of the tower unit, and is capable of not only traversing the length of the tower column but also rotating both horizontally and vertically thereabout, allowing the sensor unit to articulate and be selectively positionable adjacent the target object regardless of the target object's location. The electronics unit is selectively engagable with the tower unit and provides a portable computing device configured for remotely operating the sensor unit a safe distance away.

### RELATED APPLICATIONS

This application claims priority and is entitled to the filing date of U.S. Provisional Application Ser. No. 61/227,199, filed Jul. 21, 2009 and entitled “Portable Detection Apparatus.” The contents of the aforementioned application are incorporated herein by reference.

### INCORPORATION BY REFERENCE

Applicant hereby incorporates herein by reference any and all U.S. patents and U.S. patent applications cited or referred to in this application.

### TECHNICAL FIELD

Aspects of this invention relate generally to scanning devices, and more particularly to a portable, multi-planar detection apparatus configured for scanning suspect objects to determine whether they contain explosive or other threat or illicit materials.

### BACKGROUND ART

Generally speaking, the current trend of increased terrorist activity, including the tragic events of the September 2011 attacks, the London and Madrid transit bombings, the Mumbai urban attacks, and the like, along with the growth in the illicit trade of narcotics and other banned substances, such as radiological materials, has put tremendous pressure on all governments, the private sector, and other relevant institutions to implement tighter and more effective security solutions. Additionally, the sheer volume of the current levels of international travel and trade further complicates the problems already associated with inspecting cargo at ports of entry and departure.

The efficient movement of goods as well as the surety of public transportation, aviation, and tourism are largely reliant on the ability to rapidly and accurately identify and communicate threats against passengers, employees, guests, vehicles, and facilities. Public transportation systems, transportation terminals, airports, hotels, shopping centers, and other large public venues in particular are vulnerable to terrorist attacks, which place entire communities and even national security at risk. Significant economic losses and interruption of vital services can result from even short-term disruptions. A single incident of service interruption by suspicious or unattended packages for example has a large operational, psychological (in terms of public confidence), and economic impact that expands to other vital sectors of the nation's critical infrastructure.

Presently, the detection of concealed contraband is based mainly on the use of technologies such as X-rays, vapor detection, and sniffing dogs. These are generally considered “anomaly” detectors, since they infer that an object or a contained substance might be an explosive, illicit substance, or other contraband based upon content, density, shape, or heat. However, while anomaly detectors are useful for flagging “suspicious” items, they cannot determine for sure whether the object or contents in question actually are explosives, illicit substances, or biological agents, or merely some harmless substance. The only way to make this determination is to subject the object or its contents to supplemental inspections, or secondary “confirmation” detection methodologies, such as chemical analysis. By way of example, X-rays are widely used for bulk package surveillance since they have many advantages: the production of X-ray detection technologies are advanced and relatively inexpensive; the machines are of a reasonable size; and their presence is accepted in public places. However, X-rays suffer from the main disadvantage of having a small interaction probability with the low-electron density elements from which organic materials, including most explosives and illicit drugs, are composed. Therefore, all these substances have undistinguished X-ray absorption or incoherent scattering characteristics. In addition, although some X-ray scanners can produce a sharp image as well as density-dependent shading of the interrogated object, explosives, illicit substances, and other contraband can be molded or packed into any form to thwart the system. Also, X-rays in particular are susceptible to false negatives because of the inability to see through relatively dense shielding or masking that is usually employed to hide contraband and threat materials. Further, X-ray systems rely heavily on operator interpretation of the image captured. Even though some newer X-ray machines incorporate automated image recognition to determine whether an image indicates a suspicious object instead of relying on the operator, they cannot conclusively identify the contents, so the suspect target still must be opened and manually inspected. This makes detection by anomaly detectors such as X-rays in many cases unreliable and unsafe and prone to an unacceptable rate of false alarms.

Accordingly, the global environment and the requirements for more accurate and rapid screening, and the limitations and burdens posed by anomaly detectors, such as X-rays, have stimulated the need to develop and adopt more sophisticated and novel techniques, which can provide confirmatory screening. One of these alternative methods includes neutron activation analysis by means of highly penetrating fast neutrons and gamma spectroscopy. This “confirmatory” technique can be used to detect hidden contraband and other threat materials, including explosives, radionuclides, metals (indicative of shielding or potential shrapnel) and certain chemical agents, in packages ranging in size from small mail items to large cargo containers, and even if shielded or masked.

Neutron interrogation techniques, such as fast neutron activation analysis, generally rely on bombarding the nuclei in the interrogated object with neutrons, causing them to emit characteristic gamma rays or alter the energy of the interrogating neutrons. This radiation is generated at very specific energies, characteristic of each of these elements. A high resolution detector collects this radiation and, through specialized electronics and software, generates a spectrum of the detected radiation. This spectrum is simply a count rate at each energy bin. By correlating these spectra with known spectra for various elements, chemical identification of the composition of the subject can be made. Thus, this process reveals the presence as well as amount (or absence) of suspect substances within the subject.

In most practical situations, background components are significant; hence the sensitivity and specificity of the fast neutron activation analysis approach generally hinges on its ability to distinguish the gamma energy signatures of the concealed suspect substance clearly from the background. As such, objects must be carefully scanned in order to distinguish, with high selectivity, between the signature of a suspect substance and the signals from the overwhelming majority of innocuous substances potentially surrounding it. Additionally, current neutron activation/gamma spectroscopy technology, such as fast neutron activation analysis, lacks directionality and range. As a result, large areas require numerous scans that, in turn, require a significant amount of time and computer processing for an object to be fully interrogated.

Neutron activation based scanning thus presents a number of problems. First, accurately scanning an entire object using currently known fast neutron activation analysis techniques may be too slow for practical use in certain contexts such as screening luggage in airports. In situations where explosives are present, explosives need to be identified as soon as possible to facilitate effective responses. Second, the more time that a fast neutron activation analysis device scans an object, the more neutron radiation is released into the immediate environment, thus creating the potentially harmful situation of increased radiation exposure for nearby persons. Additionally, from an equipment standpoint, both the neutron generator and high resolution detector are subject to wear with increased exposure to the neutron emissions. Third, in order to perform multiple scans of a larger object, the typical neutron activation based scanner must be shut down or deactivated for repositioning then restarted or reactivated between successive scans, thus increasing the amount of time to fully interrogate the object as well as the time the user spends near the object or in the immediate area of risk while repositioning.

A further disadvantage of the prior art approaches is that neutron activation analysis scanning devices have been large and generally immobile. They are typically configured as vehicle borne systems which due to their size cannot access interior spaces such as transit stations, rail cars, or hotel lobbies, or as fixed portals which require subject objects to be brought to them for scanning, rather than the scanning devices themselves traveling to the objects. For example, in the context of airport luggage screening, luggage is often placed on a conveyor belt, which moves luggage through the stationary scanning device. While this may be efficient in the context of airport luggage screening and the like, it is not effective in other contexts where physically handling or moving the suspect object is inherently dangerous, such as when the object is a parcel or bag left unattended or abandoned in a public area, in an overhead compartment of an airplane, or in other spaces having limited access. This is especially true when the object has already been flagged as suspicious and has a higher threat profile.

Additionally, in situations where the user is not aware of either the destructive range of or their proximity to the discovered explosive, there is a great deal of danger for both the user and the nearby public. As such, in operating such a scanning device, it is imperative that operation of the device, including movement of the sensor over larger areas, to be accomplished remotely, allowing human operators to remain a safe distance away from a suspect object and outside of a potential blast radius, in the case of explosives, or possible contamination zone, in the case of radionuclide.

The following art defines the present state of this field:

U.S. Pat. No. 4,387,468, issued on Jun. 7, 1983 to Fenne et al. is generally directed to a mobile X-ray apparatus comprising a base and a column on the base and rotatable about a vertical axis. A carriage is mounted for upward and downward movement on the column and an arm is mounted on the carriage for movement therewith. On one end of the arm is an X-ray tube head assembly which is rotatable with the column about its vertical axis throughout a 180 degrees. The tube head assembly is counterweighted by an X-ray film cassette bin plus control circuitry for operating the X-ray tube, together with the housing for the control circuitry. The tube head assembly may be placed in a storage and transport position in which the tube head is well within the confines of the base of the unit, thereby contributing to the stability of the unit.

U.S. Pat. No. 4,918,315, issued on Apr. 17, 1990 to Gomberg et al., is generally directed to a system and method for the inspection and/or search for concealed objects which impinges a monoenergetic neutron beam upon an object, notes the energy distribution of the neutrons scattered from the object and correlates the energy/intensity distribution of the scattered neutrons with the presence or absence of particular elements. The invention may be utilised to obtain qualitative or quantitative data regarding the composition of the object under interrogation.

U.S. Pat. No. 5,499,284, issued on Mar. 12, 1996 to Pellegrino et al., is generally directed to an improved mobile X-ray unit having a counterweighted articulating X-ray tube support arm that allows positioning of an attached X-ray tube virtually without the need for moving a supporting carriage. The improved mobile X-ray unit also allows the X-ray tube to be locked to the supporting carriage during travel and the articulating X-ray arm includes several electro-magnetically actuated disk brakes capable of locking the articulating X-ray arm in a predetermined position. In the event that the carriage movement is required, the carriage may be moved by application of force on a force sensing handle engaged with the carriage by two strain gage assemblies. The strain gage assemblies provide signals to a motor drive control circuits which in turn propel two driven wheels in the direction and proportional to the force applied to the handle relative to the carriage.

U.S. Pat. Nos. 5,982,838 and 6,563,898, issued on Nov. 9, 1999 and May 13, 2003, respectively, to Vourvopoulos, is generally directed to a method and portable apparatus which is used to detect substances, such as explosives and drugs, by neutron irradiation. The apparatus has a portable neutron generating probe and corresponding controllers and data collection computers. The probe emits neutrons in order to interrogate an object. The probe also contains gamma ray detectors for the collection of gamma rays from fast neutron, thermal neutron and neutron activation reactions. Data collected from these detectors is sent to the computer for data de-convolution then object identification in order to determine whether the object being interrogated contains explosives or illicit contraband.

U.S. Pat. No. 6,007,243, issued on Dec. 28, 1999 to Ergun et al., is generally directed to a compact mobile X-ray C-arm system employing a cart supporting a video monitor on a top shelf and other imaging equipment on lower shelves opening from the front of the cart. The C-arm is supported by a pivot attached to the side of the cart below the platform allowing the C-arm to extend forward without obstructing the shelves or video monitor and yet providing for a balanced operation permitting a smaller footprint area of the cart. Use of the C-arm as a heat sink for the X-ray source and swiveling casters to allow an additional axis of rotation allow a more compact structure to be produced.

U.S. Pat. No. 7,319,738, issued on Jan. 15, 2008 to Lasiuk et al., is generally directed to a mobile radiographic device for use in inspecting pipelines and the like, comprising an articulating aerial boom coupled to a mobile carriage vehicle. A pivot mount is rotatably coupled to the distal end of the aerial boom. A platform having a sliding rail is operatively coupled to the pivot mount. A mounting fixture is rotatably mounted to a cradle, which in turn is coupled to the sliding rail of the platform. A radiation source and a radiation detector are mounted on diametrically opposing sides of the fixture in order to illuminate the outer surface of a pipeline or other object with radiation. A first positioning means is provided for coarsely positioning the scanning apparatus relative to the pipeline. A second positioning means is provided for finely positioning the scanning apparatus relative to the pipeline. The second positioning means is operable from a remote location when the radiation source is illuminating the pipeline with radiation. The first and second positioning means provide a plurality of degrees of freedom for positioning the scanning apparatus.

The prior art described above teaches various types of mobile and/or portable scanning devices configured for detecting whether an interrogated object contains particular elements, including explosives or illicit contraband. However, the prior art fails to teach such a portable detection apparatus having a modular design that not only allows for relatively easy storage and deployment, but also enables scanning to be performed remotely on objects of varying dimensions from many different positions, orientations and angles, as well as at various heights, even when those objects are located in relatively confined spaces. Aspects of the present invention fulfill these needs and provide further related advantages as described in the following summary.

### DISCLOSURE OF THE INVENTION

Aspects of the present invention teach certain benefits in construction and use which give rise to the exemplary advantages described below.

The present invention solves the above-described problems by providing a portable detection apparatus configured for scanning suspect objects to determine whether they contain explosive or other threat or illicit materials, as herein described below.

The apparatus comprises, in an exemplary embodiment, a tower unit, a sensor unit and an electronics unit, each configured to be removably engagable with one another for relatively quick disassembly during transport and storage and reassembly during use. Additionally, each of the units are sized and configured for being able to operate in relatively confined spaces. The tower unit comprises a tower base having a relatively vertically oriented tower column, with a tower collar both slidably and rotatably engaged with the tower column. Thus, the tower collar is able to traverse the length of, as well as horizontally rotate 360 degrees around, the tower column. An arm mount is pivotally engaged with the tower collar and provides a slidably mounted extender arm. This configuration allows the extender arm to vertically rotate 360 degrees relative to the tower collar. Additionally, the extender arm provides a sensor mount configured for selectively receiving a sensor receptacle of the sensor unit. The sensor unit also provides a means for scanning the target object. Thus, with the sensor unit so engaged with the tower unit, the sensor unit is able to articulate into a wide range of positions so as to be selectively positionable adjacent the target object, virtually regardless of the target object's location. The electronics unit is selectively engagable with the tower unit as well, and provides a portable computing device configured for remotely operating the sensor unit a safe distance away from the target object.

In use, an operator transports each of the tower unit, sensor unit and electronics unit to where the target object is located. The tower unit is then positioned proximal the target object and the electronics unit is engaged with the tower base for stabilising and providing sufficient counterweight to the tower unit. The sensor unit is selectively engaged with the extender arm in one of either a substantially horizontal or vertical scan direction, depending on the position and orientation of the target object. The extender arm is then selectively articulated such that the means for scanning the target object is positioned substantially adjacent the target object. Finally, the portable computing device is relocated a safe distance away from the target object and used to remotely operate the sensor unit to scan the target object.

A primary objective inherent in the above described apparatus and method of use is to provide advantages not taught by the prior art.

Another objective is to provide such an apparatus that has a modular design that not only allows for relatively easy storage and deployment, but also enables scanning to be performed on objects from many different positions, orientations and angles, as well as at various heights, even when those objects are located in relatively confined spaces.

A further objective is to provide such an apparatus that is capable of being remotely operated from a safe distance.

A still further objective is to provide such an apparatus that is capable of determining how far the operator must move away from the apparatus and target object to be safe.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a side elevational view of an exemplary embodiment of the present invention, showing the invention in both an assembled and disassembled state;

FIG. 2 is a front elevational view thereof;

FIG. 3 is a side elevational view thereof;

FIG. 4 is a rear elevational view thereof;

FIG. 5 is a detailed view of a pair of stabilizer legs engaged with a tower unit of an exemplary embodiment of the present invention;

FIG. 6 is a sequence view of the tower unit, illustrating the wide range of rotational positions that an extender arm of the tower unit is capable of;

FIG. 7 is a sequence view of the tower unit as transitioning between a deployed state and a transport state;

FIG. 8 is a sequence view of the present invention, illustrating the engagement between an electronics unit and the tower unit;

FIG. 9 is a detailed view of the exemplary embodiment of the present invention, illustrating the various positioning capabilities of a sensor unit for scanning a target object;

FIGS. 10 and 11 are side elevational views of a further embodiment of the present invention, with a secondary mount engaged with an extender arm of the tower unit;

FIG. 12 is a perspective view of the electronics unit;

FIGS. 13 and 14 are side elevational views thereof;

FIG. 15 is a detailed perspective view thereof;

FIG. 16 is a partial exploded perspective view of the exemplary embodiment of the present invention;

FIGS. 17 is a sequence view of the further embodiment of the present invention, illustrating the sensor unit's ability to rotate a full 360 degrees about the extender arm when installed on the secondary mount; and

FIG. 18 is a perspective view thereof.

### MODES FOR CARRYING OUT THE INVENTION

The above described drawing figures illustrate aspects of the invention in at least one of its exemplary embodiments, which are further defined in detail in the following description.

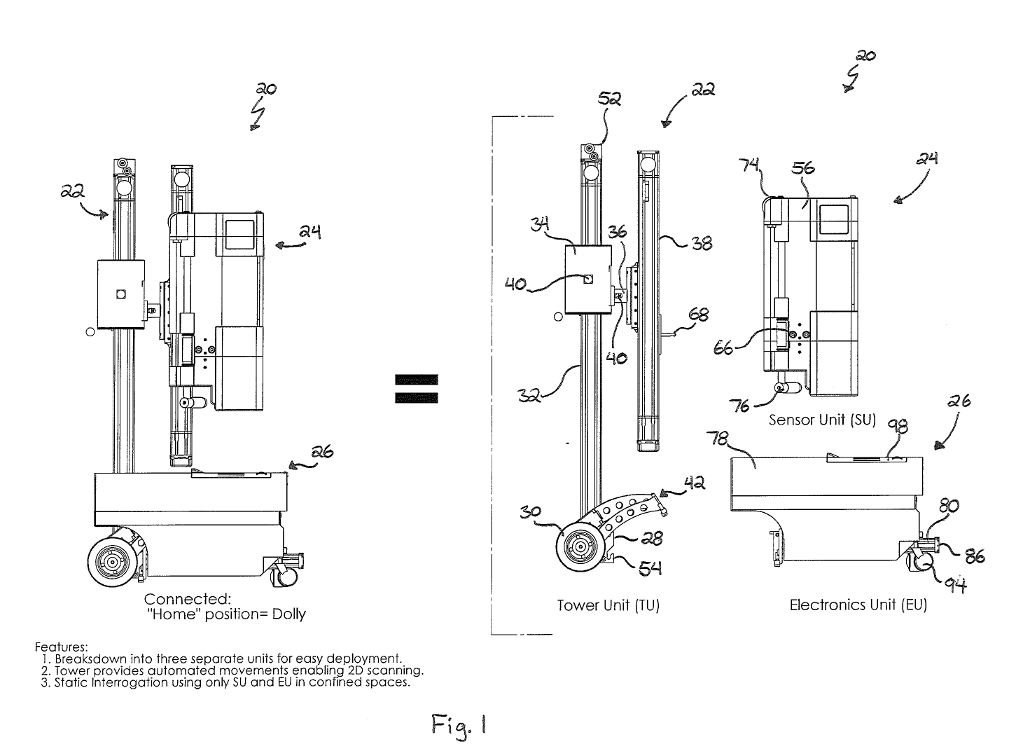

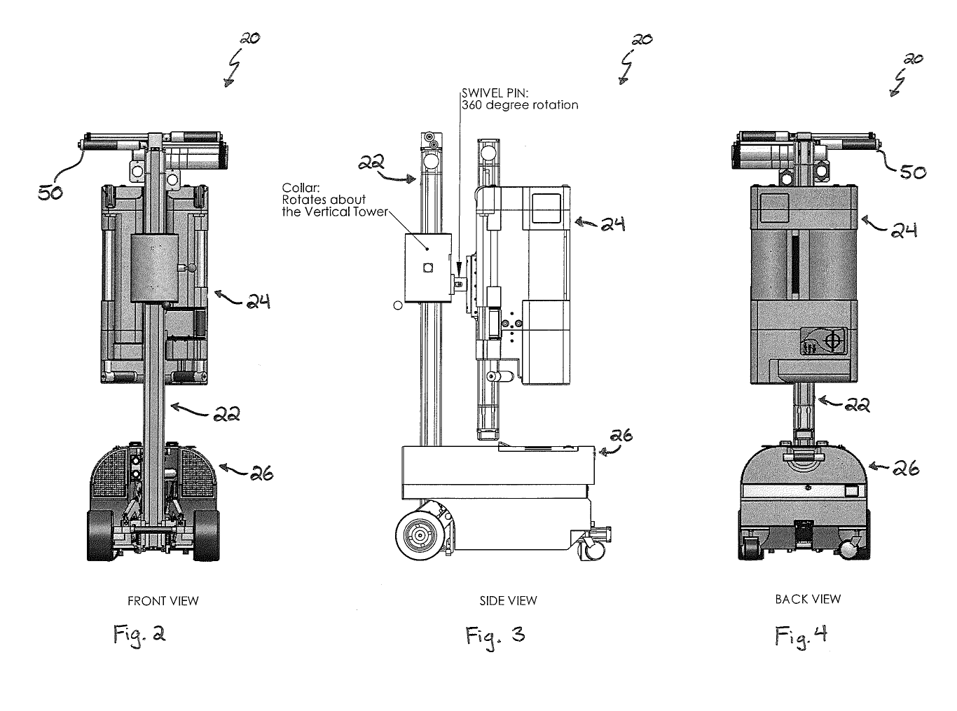

Turning now to FIG. 1, there is shown a side elevational view of an exemplary embodiment of a portable detection apparatus 20. The apparatus 20 comprises, in the exemplary embodiment, a tower unit 22, a sensor unit 24, and an electronics unit 26, each configured to be removably engagable with one another as best shown in FIGS. 1-4. Thus, these three modular units 22, 24 and 26 are capable of being quickly disassembled for transport and storage, and reassembled to perform scans after deployment to a target site. Additionally, each of the units 22, 24 and 26 are sufficiently compact and narrow to allow the apparatus 20 to fit in relatively confined spaces, such as an aisle in a commercial airplane.

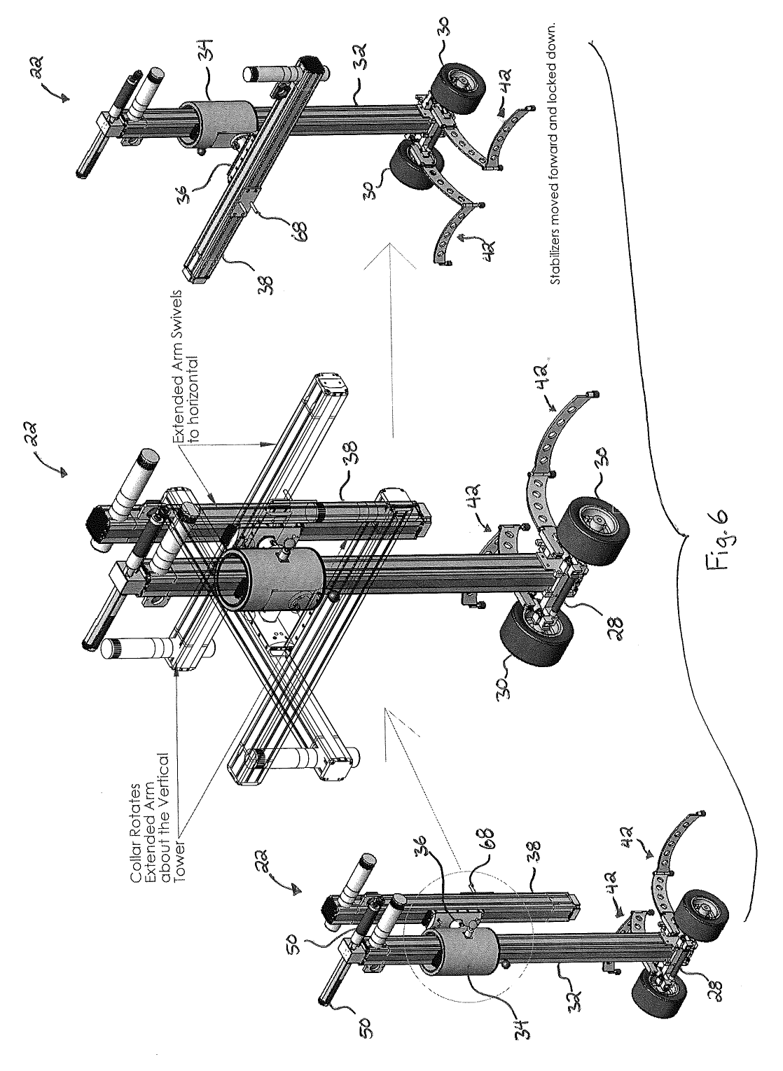

With continued reference to FIGS. 1-4, the tower unit 22 comprises, in the exemplary embodiment, a tower base 28 having a set of opposing tower wheels 30 and a relatively vertically oriented, linearly actuated, tower column 32. A tower collar 34 is both slidably and rotatably engaged with the tower column 32, thus allowing the tower collar 34 to traverse the length of, as well as horizontally rotate 360 degrees around, the tower column 32. Additionally, an arm mount 36 is pivotally engaged with the tower collar 34 and provides a slidably mounted extender arm 38 configured for removable engagement with the sensor unit 24, such engagement explained in detail below. The sequence shown in FIG. 6 illustrates the wide range of rotational positions that the extender arm 38 is capable of. Given its connection to the tower collar 34, the extender arm 38 is also able to traverse the length of, as well as horizontally rotate 360 degrees around, the tower column 32. Furthermore, the extender arm 38 is able to vertically pivot 360 degrees via the arm mount 36 as well as traverse the length of the arm mount 36. In one embodiment, movement and positioning of both the tower collar 34 and extender arm 38 is accomplished manually, such as with locking pins 40 or any other means now known or later developed. In another embodiment, movement and positioning of the tower collar 34 and extender arm 38 is accomplished through motorization, such as with linear actuators or any other means now known or later developed.

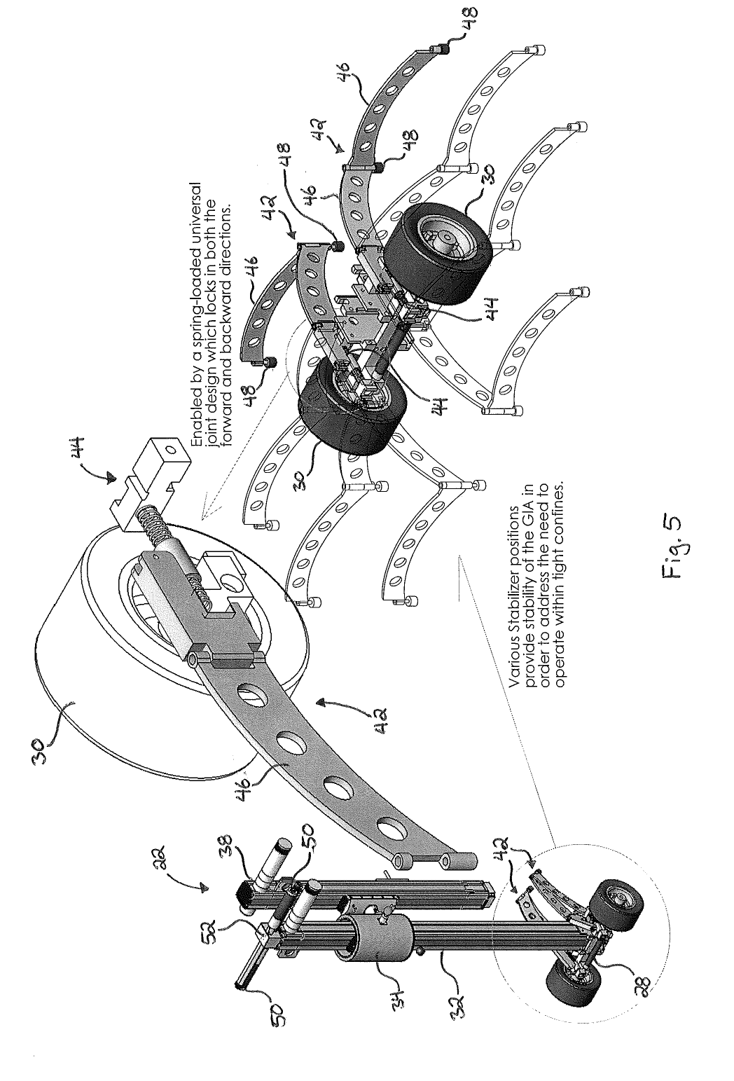

As best shown in FIG. 5, a pair of opposing stabilizer legs 42 are pivotally engaged with the tower base 28 and configured for selectively moving between a deployed state, wherein the stabilizer legs 42 are extended for stabilizing the tower unit 22 during use, and a retracted state, wherein the stabilizer legs 42 are folded inwardly during transport of the tower unit 22. In the exemplary embodiment, each of the stabilizer legs 42 are secured to the tower base 28 by a spring-loaded universal joint 44 and comprise at least two elongate leg portions 46 pivotally joined with one another. Thus, as FIG. 5 demonstrates, the stabilizer legs 42 are able to be moved into a wide range of positions in order to adequately stabilize and compensate for the weight distribution of the apparatus 20 during use, which can depend on a number of factors including the surface grade on which the apparatus 20 is positioned as well as the positioning of the sensor unit 24. It should be noted that, in alternate embodiments, the apparatus 20 may provide further stabilizer legs or other means for stabilizing the present invention during use. In one embodiment, movement and positioning of the stabilizer legs 42 is accomplished manually. In another embodiment, it is accomplished automatically. The stabilizer legs 42 also preferably provide a set of selectively extendable stabilizer feet 48, as best shown in FIG. 5, configured for adding needed height to the stabilizer legs 42 when the apparatus 20 is positioned on an uneven surface. In one embodiment, the stabilizer feet 48 are manually extendable. In another embodiment, the stabilizer feet 48 are automatically extendable, such as with a spring-loaded self-locking mechanism, or any other means now known or later developed. Moreover, while the stabilizer feet 48 are shown as rubber or other such pads, one or more of the feet 48 may instead be configured as castors to facilitate support and movement of the tower unit 22 particularly in its lone state (without the sensor unit 24 and/or the electronics unit 26).

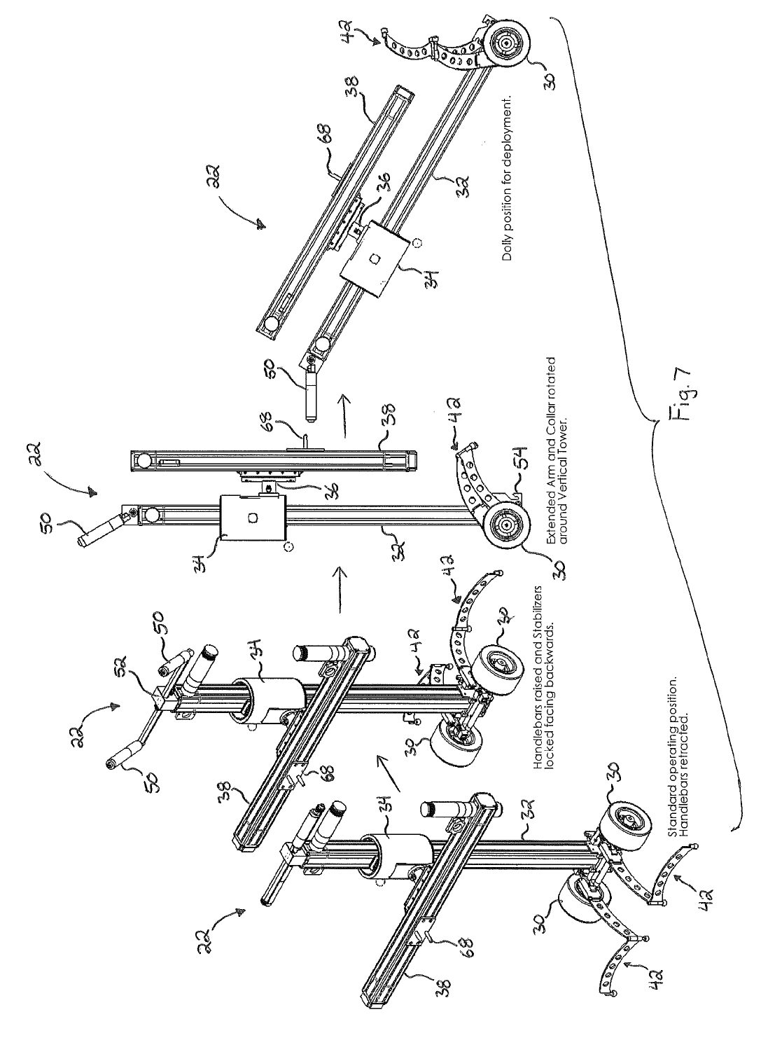

With continued reference to FIG. 5, the tower unit 22 also preferably provides a pair of retractable tower handles 50 engaged with an upper end 52 of the tower column 32 and configured for assisting in the transport of the tower unit 22. As best shown in the sequence of FIG. 7, to transport the tower unit 22, the tower handles 50 are simply extended, and the tower unit 22 tipped back onto the tower wheels 30, thereby allowing a user to dolly the tower unit 22 into position for deployment or storage.

As best shown in FIG. 1, the tower base 28 further provides a base hook 54 configured for removable engagement with the electronics unit 26, such engagement explained in detail below.

With continued reference again to FIG. 1, the sensor unit 24 comprises, in the exemplary embodiment, a sensor housing 56 providing a neutron generator 58 and a high resolution detector 60 (FIG. 9). As best shown in FIG. 9, the neutron generator 58 and detector 60 are preferably positioned on the same side of the sensor housing 56 such that, when the sensor unit 24 is adjacent a target object 62, both the neutron generator 58 and detector 60 are able to operate on the same portion of the target object 62 without having to reposition the sensor unit 24. It should be noted that while the exemplary embodiment of the sensor unit 24 provides a neutron generator 58 and detector 60 for performing nuclear scanning methods such as fast neutron activation analysis, the sensor unit 24 may provide other types of scanning hardware in alternate embodiments in order to perform other types of scanning methods, such as X-ray scanning. As such, it is to be understood that the present invention is not in any way limited to only fast neutron activation analysis scanning and the like, but instead may be employed in conjunction with any scanning or detection technology now known or later developed.

The sensor housing 56 also provides, in the exemplary embodiment, a horizontal sensor receptacle 64 and a vertical sensor receptacle 66 each substantially ninety degrees apart from the other and configured for removable engagement with a sensor mount 68 located on the extender arm 38. In one embodiment, as best shown in FIG. 9, the sensor mount 68 is configured as a dual pin, with the horizontal and vertical sensor receptacles 64 and 66 each configured as a corresponding dual pin receptacle. In alternate embodiments, the sensor mount 68 may be any other means operable on the extender arm 38 for removable engagement with the sensor housing 56, now known or later developed. With continued reference to FIG. 9, when the sensor mount 68 is engaged with the horizontal sensor receptacle 64, the sensor unit 24 is thus in the “Looking Out” position and is capable of scanning the target object 62 in the horizontal direction. Alternatively, when the sensor mount 68 is engaged with the vertical sensor receptacle 66, the sensor unit 24 is thus in the “Looking Up” or “Looking Down” position and is capable of scanning the target object 62 in the vertical direction, i.e., from above or below the target object 62. Additionally, as mentioned above, because the sensor unit 24 is removably mounted to the extender arm 38, the sensor unit 24 is capable of traversing the length of, as well as horizontally rotating 360 degrees around, the tower column 32, in addition to vertically pivoting 360 degrees via the arm mount 36. Thus, the sensor unit 24 is capable of scanning the target object 62 from many different positions/orientations and angles, and at various heights, even in relatively confined spaces.

In a further embodiment, the sensor mount 68 is slidably engaged with the extender arm 38, allowing the sensor unit 24 to traverse the length of the extender arm 38 as well, thereby increasing the maximum height at which the sensor unit 24 is able to scan.

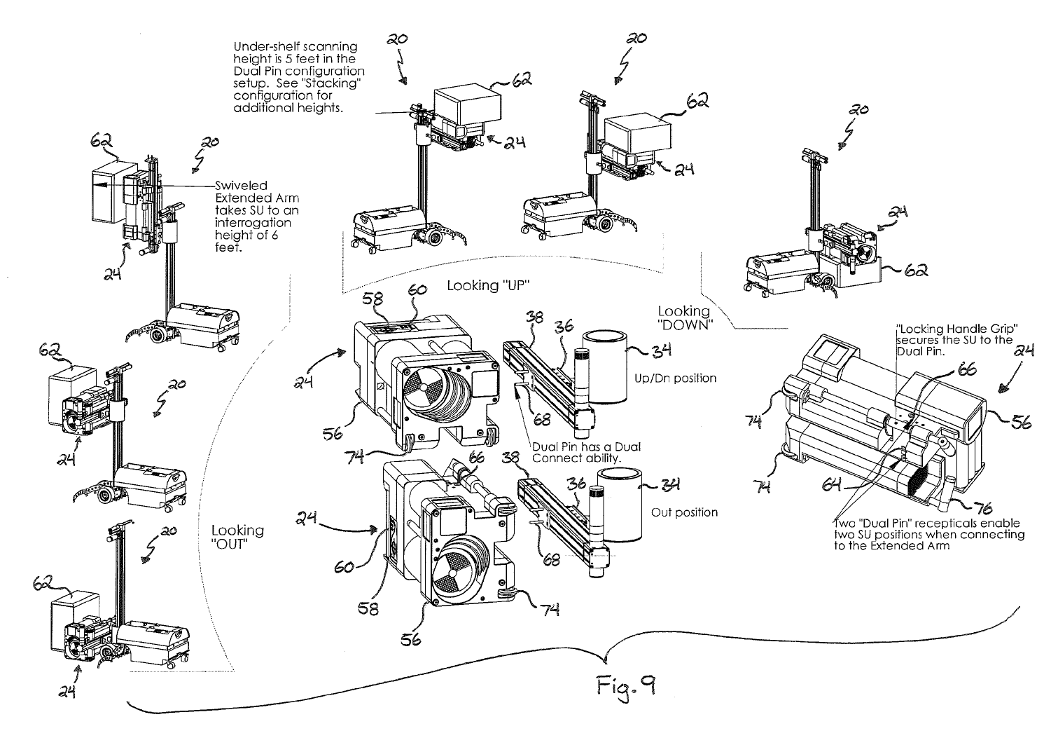

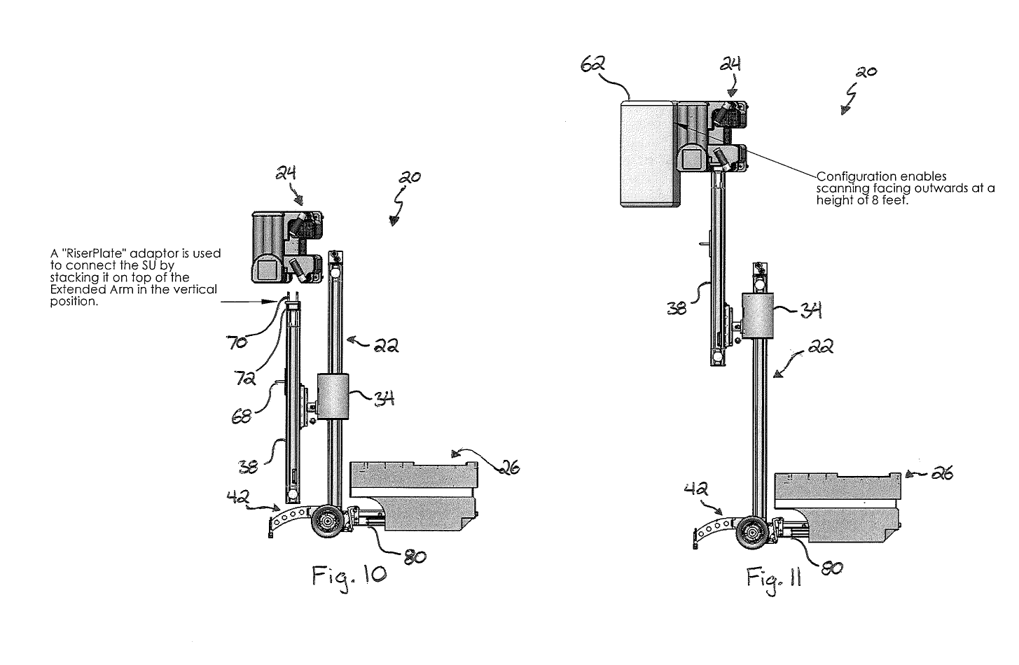

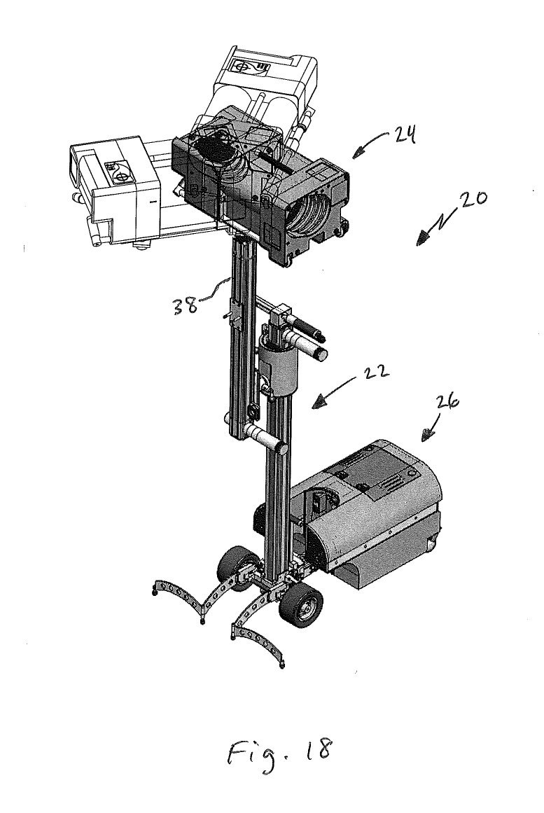

As shown in FIGS. 10 and 11, a secondary “Riser Plate” mount 70 may be engaged with an end 72 of the extender arm 38. Thus, with the extender arm 38 oriented relatively vertically and the sensor unit 24 engaged with the secondary mount 70, the sensor unit 24 is able to scan at even greater heights, whether horizontally or vertically, i.e., “Looking Out” or “Looking Up.” Referring to FIGS. 17 and 18, in a still further embodiment, the secondary mount 70 includes a swivel plate 71 that is pivotally engaged with the end 72 of the extender arm 38, thereby enabling the sensor unit 24 when installed on the secondary mount 70 to rotate a full 360 degrees about the end of the extender arm 38, as best shown in FIG. 18. Thus, the swivel plate 71 adds rotational ability in the sensor unit 24's stacking position, such that horizontal rotation is not lost even when operating the scanning apparatus 20 at maximum height. Ultimately, according to aspects of the invention in this still further alternative embodiment, the sensor unit 24 is able to get into position within tight confines even at relatively widely varying heights, especially in consideration of such challenging spaces as overhead storage bins within passenger cabins of commercial airplanes. Once again, those skilled in the art will appreciate that while the riser swivel plate 71 is shown and described in the context of a particular mechanical construction, other such structural elements now known or later developed may be employed without departing from the spirit and scope of the invention.

The sensor unit 24 also preferably provides a gyroscope (not shown) configured for determining the current orientation of the sensor unit 24 during use of the apparatus 20. This information assists in performing more accurate scans of the target object 62, as well as ensures that the apparatus 20 is properly stabilised before a scan begins.

Similar to the tower unit 22, the sensor unit 24 provides a pair of sensor wheels 74 and retractable sensor handles 76 (FIG. 9), allowing the sensor unit 24 to be easily transported to the desired destination when the apparatus 20 is disassembled.

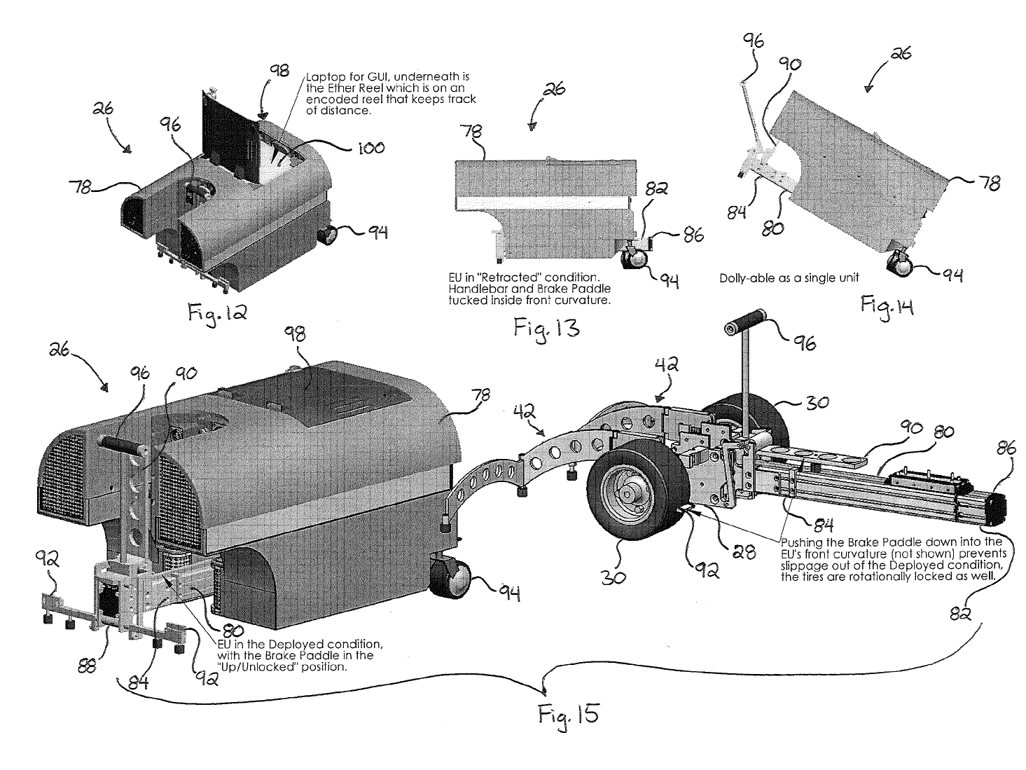

As shown in FIGS. 12-15, the electronics unit 26 comprises, in the exemplary embodiment, an electronics housing 78 slidably engaged on an elongate housing shaft 80 and configured for moving between a deployed state wherein the electronics housing 78 is moved toward a distal end 82 of the housing shaft 80, exposing a proximal end 84 of the housing shaft 80 (FIGS. 14 and 15), and a retracted state wherein the electronics housing 78 is moved toward the proximal end 84 (FIGS. 12 and 13). Similar to the stabilizer legs 42, the deployed state of the electronic housing 78 is configured for adequately stabilizing and compensating for the weight distribution of the apparatus 20 during use.

As best shown in FIG. 15, the distal end 82 of the housing shaft 80 provides a housing stopper 86 that properly positions the electronics housing 78 and limits its movement on the housing shaft 80. The proximal end 84 provides an engagement rod 88, configured for removable engagement with the base hook 54 (FIG. 1) of the tower unit 22 during use of the apparatus 20. The proximal end 84 further provides a brake paddle 90 configured for selectively locking the electronics housing 78 in the deployed state when the brake paddle 90 is rotated downward into a locked position. The brake paddle 90 is also equipped with a set of wheel locks 92 configured for engaging and rotationally locking the tower wheels 30 when the brake paddle 90 is in the locked position. Thus, the brake paddle 90 ensures that the electronics housing 78 remains in the deployed state and that the tower unit 22 remains stationary when the apparatus 20 is in use.

Additionally, similar to the tower unit 22 and sensor unit 24, the electronics unit 26 provides a pair of electronics wheels 94 and an electronics handle 96 (FIG. 14), allowing the electronics unit 26 to be easily transported to the desired destination when the apparatus 20 is disassembled.

The electronics unit 26 is in communication with the sensor unit 24 so as to enable the exchange of data and commands therebetween. This communication may be accomplished via any type of wired or wireless communication protocol, now known or later developed. As shown in FIG. 12, the electronics housing 78 preferably provides a compartment 98 configured for storing a portable computing device 100, such as a laptop computer. In the preferred embodiment, the apparatus 20 is controlled via a graphical user interface (“GUI”) on the portable computing device 100. During storage and transport of the apparatus 20, the portable computing device 100 is stored in the compartment 98; and when the apparatus 20 is deployed and in use, the portable computing device 100 is removed and taken to a remote location for the user to safely operate the apparatus 20, as described in more detail below.

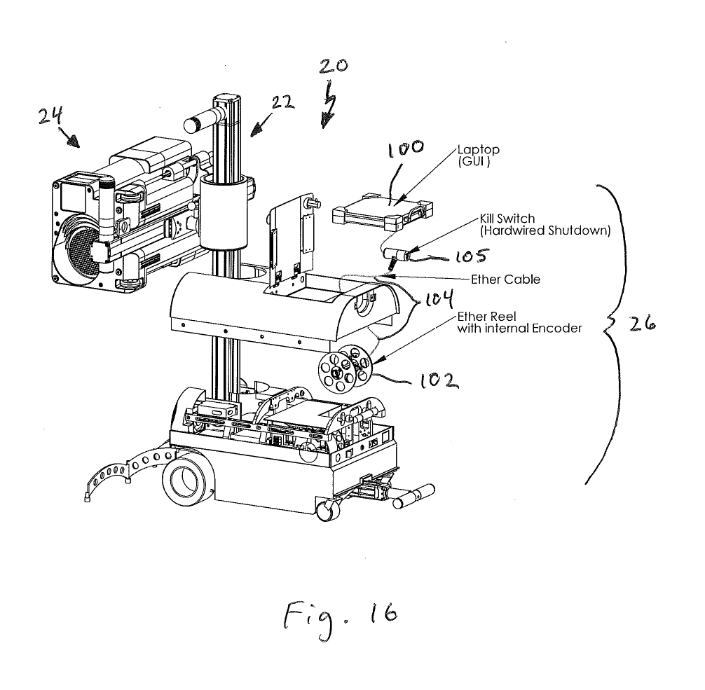

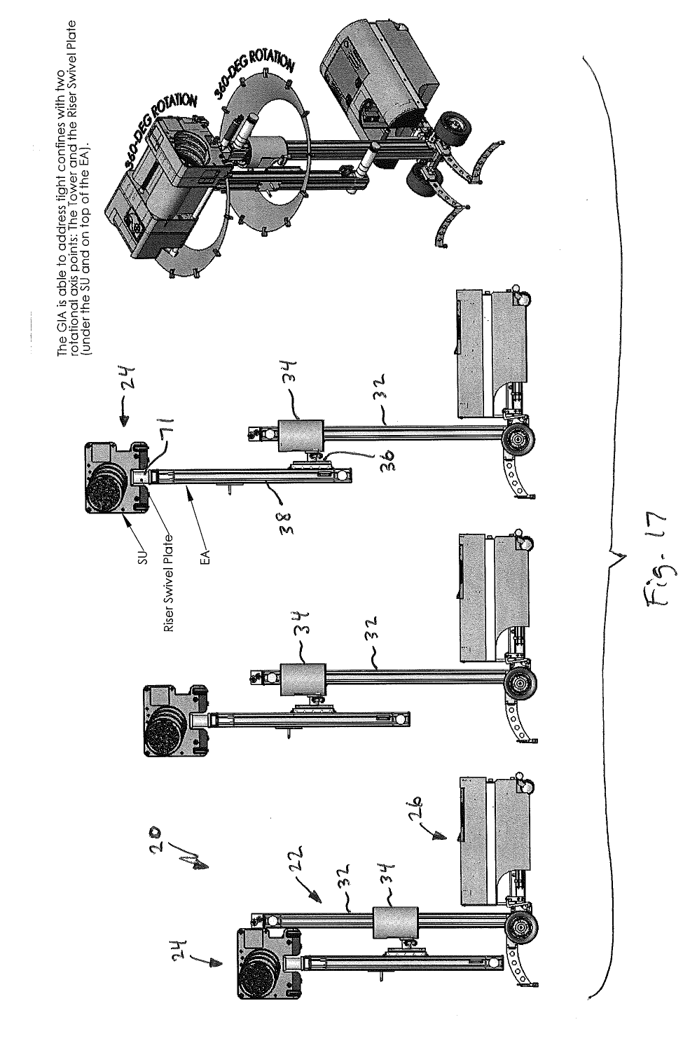

In the exemplary embodiment, shown best in FIG. 16, the electronics unit 26 also provides an ether reel 102 having a length of cable 104 interconnecting the portable computing device 100 and electronics unit 26, which is roughly seventy-five to one hundred fifty feet (75-150′) in the exemplary embodiment, but can be basically any length appropriate to the context. The motorized ether reel 102 has an incremental encoder (not shown) configured for tracking the amount of cable 104 that is let out from the ether reel 102 and, by extension, how far the portable computing device 100 is from the rest of the electronics unit 26. This information according to aspects of the present invention allows verification not only that the user is a safe distance from the apparatus 20 before it will allow the scanning process to begin, but it can also be used to alert the user if they are not a safe distance from a discovered explosive, as discussed in detail below. In alternative wireless embodiments, wherein the electronics unit 26 and the portable computing device 100 are linked and in communication via cellular, RF, infrared, or other wireless transmission technologies now known or later developed, it will be appreciated that the spatial position of the electronics unit 26, and effectively the adjacent target object 62, may be determined using GPS or other such technology now known or later developed and the distance between the portable computing device 100 and the target object 62 determined on that basis. As a further safety mechanism, there may be a kill switch 105 hardwired within the cable 104 proximal to the portable computing device 100 so as to enable the operator, as needed, to instantly shut down the apparatus 20, and particularly the neutron generator 58 in the exemplary embodiment wherein the sensor unit 24 involves nuclear scanning such as fast neutron activation analysis.

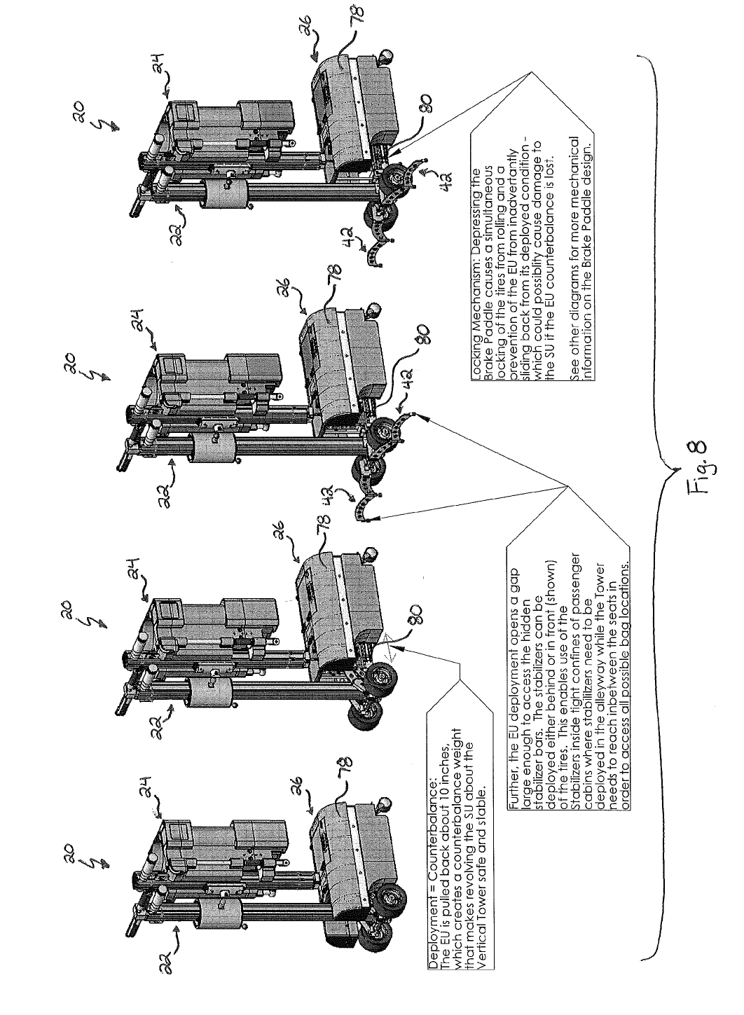

As mentioned above, each of the tower unit 22, sensor unit 24, and electronics unit 26 are configured to be removably engagable with one another and can be quickly disassembled for transport and storage and reassembled to perform scans after deployment to a target site. Thus, when the apparatus 20 is in use, each of the tower unit 22, sensor unit 24, and electronics unit 26 are manually transported to the target site where the target object 62 is located. The electronics unit 26 is then engaged with the tower unit 22 and moved into its deployed state, as shown in FIG. 8; additionally, the brake paddle 90 is moved into the locked position, as shown in FIG. 15. The sensor unit 24 is then appropriately engaged with the extender arm 38 and the stabilizer legs 42 properly positioned to compensate for the weight distribution of the apparatus 20 based on the surface grade on which the apparatus 20 is positioned as well as the positioning of the sensor unit 24. The sensor unit 24 is then moved into the appropriate position adjacent the target object 62 by adjusting the tower collar 34, extender arm 38, and/or swivel plate 71. As mentioned above, these adjustments are performed manually in one embodiment and electromechanically in an alternate embodiment. Where the adjustments are performed electromechanically, the electronics unit 26 preferably provides a tactile joystick (not shown), configured for allowing the user to precisely control at least one of the tower collar 34, tower wheels 30, stabilizer legs 42, extender arm 38, swivel plate 71, and sensor unit 24.

It should be noted that when the target object 62 is located in a confined space that is too small for the tower unit 22 to travel, the present invention can be used without the tower unit 22. In such a situation, the sensor unit 24 and electronics unit 26 are manually carried and positioned adjacent the target object 62.

It should also be noted that the various features of each of the above-described embodiments may include any logical combination of manual and automated/motorized components, such combinations intended to be included within the scope of the present invention.

Once the sensor unit 24 is properly positioned adjacent the target object 62, the user removes the portable computing device 100 from the compartment 98 of the electronics unit 26 and carries it a safe distance away from the target object 62. The portable computing device 100 is then used to remotely operate the apparatus 20 and begin the scanning process.

In a further embodiment, the sensor unit 24 provides a camera or laser or other such device (not shown) mounted to the sensor housing 56 and configured for allowing the user to remotely view the target object 62 or indicate its placement in line with the target plane of the scan while the apparatus 20 is in use. Use of a laser or time of flight camera (not shown) may also allow the system to automatically report to the operator the shape and distance of the target object 62. The laser and/or camera is in communication with the portable computing device 100 and provides data that is integrated in the operator console, thereby reducing the number of graphical interfaces with which the user must interact.

Depending on the size of the target object 62, the apparatus 20 is capable of interrogating the target object 62 in either a single scan or in multiple scans, wherein the apparatus 20, and the sensor unit 24 particularly, is either manually repositioned or electromechanically/automatically re-positioned between successive scans until the entire target object 62 has been interrogated, such repositioning being accomplished through such means as a joystick or a pre-programmed algorithm embedded in the electronics unit 26 or via the GUI interface of the portable computing device 100.

In the exemplary embodiment, wherein the sensor unit 24 provides the neutron generator 58 and detector 60, the apparatus 20 is capable of performing a two-scan method, which resolves in great part the directionality and range limitations described earlier and decreases the time required to identify explosive or other illicit materials when the size of the target object 62 prevents the sensor unit 24 from interrogating the entire target object 62 in a single scan. After electronically or spatially “marking” the upper right corner and the lower left corner of the target object 62, for example, the electronics unit 26 calculates the surface area to be scanned and creates a scan pattern that will allow the sensor unit 24 to sweep the entire target object 62 through a series of scans.

The sensor unit 24 then performs a preliminary density scan, wherein the neutron generator 58 is activated and the detector 60 is used to merely read the count rate on incoming gamma rays. The gamma count rate is proportional to the density of the matter directly in front of the neutron generator 58 and detector 60. The sensor unit 24 is moved, again either manually or automatically, along the previously created scan pattern during which the sensor unit 24 pauses over each position with a minimum of overlap. The count rate data acquired at each position is recorded and plotted on a density graph, which displays a map of the target object 62 on the portable computing device 100 with positions of different densities shown in different colors. This density information can be used manually by the user, or programmatically by the electronics unit 26, to select the areas of density that match the density of dangerous materials.

In manual mode, the user can use the portable computing device 100 to select the positions they wish to interrogate and those positions are recorded. In automatic mode, the positions that register either above the user defined threshold or within user defined ranges are recorded.

The sensor unit 24 then automatically moves to each of the selected or recorded positions on the target object 62 and performs a thorough chemical analysis interrogation. Although there are many basic types of explosives and illicit drugs that can be combined and diluted to make hundreds of variations, most consist almost exclusively of the elements hydrogen (H), carbon (C), nitrogen (N), oxygen (O), chlorine (Cl), and potassium (K). Furthermore, these substances are fortunately well separated from most common materials in one or more elemental features. Nitrogen-based explosives for example are distinguished by relatively higher proportions of nitrogen and oxygen. On the other hand, illicit drugs are generally rich in hydrogen and carbon and poor in nitrogen and oxygen. In addition, most explosives have larger densities than most everyday HCNO substances. These features may be utilized to identify the presence of explosives, illicit drugs, and other contraband hidden amongst the other material inside the target object 62.

In a further embodiment, an X-ray, still image, or other optical or visual screening process using known or to be developed hardware could be employed as a further overlay on the density scan discussed above and an additional or different pre-screening tool, though the preferred embodiment would be as an additional pre-screening tool, most likely coming first in series, then the density scan based on preliminarily detected anomalies from the X-ray or other scan, and then the full chemical interrogation based on the results of the density scan. All such screening data could be ported into a processor for analysis via TCP/IP so as to be employed seamlessly in combination.

Because the apparatus 20 in the exemplary embodiment only performs full chemical analysis interrogations on suspect portions of the target object 62, the total number of scans can be greatly reduced with the current embodiment. This reduction in scans can result in significantly faster identification of explosives and illicit materials as well as indicate their positions within the target object 62. By extension, the total amount of neutrons released can also be significantly reduced since the neutron generator 58 is active for less time, which also extends the life of the apparatus 20. As to safety, the ability to limit scan times and frequency in this manner will reduce the amount of radiation in the environment, as well as eliminate the need for the user to approach the target object 62 repeatedly, therefore allowing the user to spend less time in proximity to potentially dangerous materials and resulting in lower exposure to ionizing radiation.

From the scan data and the known geometry of the scan volume and the distances to the target object 62, an estimate of the volume under scan can be made. With this information and a knowledge of the materials detected from the results of the chemical analysis scan, combined with known formulas and densities of these materials, it is possible to make good estimates of the mass of explosives, if any, within the subject. This method is far more accurate than prior methods because of the higher accuracy in determining the volume of the scanned region; even very small volumes will be detected.

As mentioned above, the ether reel 102 is capable of determining the distance between the electronics unit 26 and the portable computing device 100 by tracking the amount of cable 104 that is let out from the ether reel 102 as the portable computing device 100 is carried to a remote location. In situations where the user is not aware of either the destructive range of or their proximity to the target object 62, there is a great deal of danger for both the user and the nearby public.

In the exemplary embodiment, wherein the sensor unit 24 incorporates the neutron generator 58 and detector 60 and the apparatus 20 performs a chemical analysis interrogation of the target object 62, the electronics unit 26 identifies the presence of possible explosives or other threat or illicit materials, as discussed above. In addition, the electronics unit 26 having the acquired information relating to the type and mass of explosives present can thus effectively calculate a potential blast radius automatically and in real time without user input. This is accomplished by the electronics unit 26 using a pre-programmed database of explosive composition properties including energetic and detonation characteristics. If the electronics unit 26 determines, based on the distance equivalent communicated by the ether reel 102 as compared to the calculated blast radius, that the user is within this potential blast radius, then the apparatus 20 will generate an alert to notify the user appropriately. The electronics unit 26 is also capable of calculating and displaying, via the portable computing device 100, how far the user must move away from the apparatus 20 and target object 62 to be safe. This “safe distance” information can also be used to calculate how far the public should be evacuated in order to ensure their safety.

It should be noted that the apparatus 20 by way of interrogation by means of fast neutron activation analysis can also determine the type and mass of any other threat materials present, such as metals (which can be indicative of the presence of shrapnel or shielding) or radionuclides (which can indicate the presence in combination with explosives of a “dirty bomb”). Therefore, the apparatus 20, through the blast radius calculation performed by the electronics unit 26, takes into consideration the hazardous effects of the projectile distance of the shrapnel, in the case of metals present, and a wider contamination area, in the case of hazardous radionuclides present.

It should also be noted that the various features of each of the above-described embodiments may be combined in any logical manner and are intended to be included within the scope of the present invention.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A portable detection apparatus for scanning a target object to determine whether it contains explosive or other threat or illicit materials, the apparatus comprising:
a tower unit comprising:
a tower base having a relatively vertically oriented tower column;
a tower collar both slidably and rotatably engaged with the tower column, allowing the tower collar to traverse the length of, as well as horizontally rotate around, the tower column;
an arm mount pivotally engaged with the tower collar and providing a slidably mounted extender arm, allowing the extender arm to vertically rotate relative to the tower collar; and
a sensor mount located on the extender arm;
a sensor unit selectively engagable with the tower unit and comprising:
a sensor housing providing a means for scanning the target object; and
an at least one sensor receptacle positioned on the sensor housing and configured for selective engagement with the sensor mount; and
an electronics unit selectively engagable with the tower unit and configured for operating the sensor unit;
whereby the tower unit, sensor unit and electronics unit are sized and configured for being able to operate in relatively confined spaces, and are capable of being disassembled for transport and storage and reassembled to perform scans after deployment with relative ease.

2. The portable detection apparatus of claim 1, wherein the electronics unit comprises an electronics housing slidably engaged on an elongate housing shaft and configured for stabilising and compensating for the weight distribution of the apparatus during use.

3. The portable detection apparatus of claim 2, wherein the tower base provides a base hook configured for removable engagement with an engagement rod of the housing shaft.

4. The portable detection apparatus of claim 2, wherein the electronics housing provides a compartment configured for storing a portable computing device for operating the sensor unit.

5. The portable detection apparatus of claim 4, wherein the electronics housing further provides an ether reel having a length of cable interconnecting the portable computing device and electronics unit, the ether reel configured for determining the distance between the electronics unit and the portable computing device by tracking the amount of cable that is let out from the ether reel as the portable computing device is carried to a remote location.

6. The portable detection apparatus of claim 5, wherein a kill switch is hardwired within the cable proximal the portable computing device so as to enable an operator, as needed, to instantly shut down the sensor unit.

7. The portable detection apparatus of claim 1, wherein a pair of opposing stabilizer legs are pivotally engaged with the tower base and configured for selectively moving between a deployed state, wherein the stabilizer legs are extended for stabilizing the tower unit during use, and a retracted state, wherein the stabilizer legs are folded inwardly during transport of the tower unit.

8. The portable detection apparatus of claim 1, wherein the means for scanning the target object comprises a neutron generator and a high resolution detector.

9. The portable detection apparatus of claim 8, wherein the neutron generator and detector are positioned adjacent one another such that, during use, each are able to operate on the same portion of the target object without having to reposition the sensor unit.

10. The portable detection apparatus of claim 1, wherein the sensor mount is configured as a dual pin, with the at least one sensor receptacle configured as a corresponding dual pin receptacle.

11. The portable detection apparatus of claim 1, wherein the at least one sensor receptacle is a horizontal sensor receptacle configured for enabling the sensor unit to scan the target object in a substantially horizontal direction, and a vertical sensor receptacle configured for enabling the sensor unit to scan the target object in a substantially vertical direction.

12. The portable detection apparatus of claim 1, wherein the sensor mount is slidably engaged with the extender arm, allowing the sensor unit to traverse the length of the extender arm for increasing the maximum range in which the sensor unit may operate without having to reposition the tower unit.

13. The portable detection apparatus of claim 1, wherein an end of the extender arm provides a secondary mount configured for selectively receiving the sensor unit when the extender arm is oriented substantially vertically, thereby increasing the maximum height at which the sensor unit may operate.

14. The portable detection apparatus of claim 13, wherein the secondary mount is pivotally engaged with the end of the extender arm, allowing the sensor unit, when engaged with the secondary mount, to horizontally rotate thereabout.

15. The portable detection apparatus of claim 1, wherein each of the tower unit, sensor unit and electronics unit provides a pair of wheels and a retractable handle to assist in transport and deployment.

16. The portable detection apparatus of claim 1, wherein the sensor unit further provides a gyroscope configured for determining the orientation of the sensor unit during use of the apparatus.

17. The portable detection apparatus of claim 1, wherein the sensor unit further provides a means for allowing the user to remotely view the target object or indicate its placement in line with the target plane of the scan during use of the apparatus.

18. A portable detection apparatus for scanning a target object to determine whether it contains explosive or other threat or illicit materials, the apparatus comprising:
a tower unit comprising:
a tower base having a relatively vertically oriented tower column;
a tower collar both slidably and rotatably engaged with the tower column, allowing the tower collar to traverse the length of, as well as horizontally rotate around, the tower column;
an arm mount pivotally engaged with the tower collar and providing a slidably mounted extender arm, allowing the extender arm to vertically rotate relative to the tower collar; and
a sensor mount located on the extender arm;
a sensor unit comprising:
a sensor housing providing a means for scanning the target object;
a horizontal sensor receptacle positioned on the sensor housing and configured for selective engagement with the sensor mount, enabling the sensor unit to scan the target object in a substantially horizontal direction; and
a vertical sensor receptacle positioned on the sensor housing substantially ninety degrees apart from the horizontal sensor receptacle and configured for selective engagement with the sensor mount, enabling the sensor unit to scan the target object in a substantially vertical direction; and
an electronics unit selectively engagable with the tower unit and comprising:
an electronics housing providing a compartment configured for storing a portable computing device for operating the sensor unit; and
a means for determining the spatial distance between the portable computing device and the electronics housing;
whereby the tower unit, sensor unit and electronics unit are sized and configured for being able to operate in relatively confined spaces, and are capable of being disassembled for transport and storage and reassembled to perform scans after deployment with relative ease.

19. A method for scanning a target object to determine whether it contains explosive or other threat or illicit materials, comprising the steps of:
transporting each of a tower unit, sensor unit and electronics unit to where the target object is located;
positioning the tower unit proximal the target object;
engaging the electronics unit with a tower base of the tower unit;
engaging the sensor unit with an extender arm rotatably mounted on a tower collar itself slidably and rotatably mounted on a tower column of the tower unit;
articulating the extender arm and tower collar such that a means for scanning the target object of the sensor unit is positioned substantially adjacent the target object;
relocating a portable computing device of the electronics unit a safe distance away from the target object; and
using the portable computing device to remotely operate the sensor unit in order to scan the target object.

20. The method of claim 19, further comprising the steps of:
creating a scan pattern based on the surface area of the target object for allowing the sensor unit to sweep the entire target object through a series of scans;
performing a preliminary density scan of the target object along the scan pattern to create a density graph;
identifying areas of the density graph that potentially match the densities of known explosive or other illicit materials; and
performing a thorough chemical analysis interrogation on the identified areas of the target object to determine the actual presence of any explosive or other illicit materials.
